(19) United States
(12) Patent Application Publication
(10) Pub. No.: US 2016/0081765 A1
(43) Pub. Date: Mar. 24, 2016

(54) A PRECISION SURICAL GUIDANCE TOOL SYSTEM AND DELIVERY METHOD FOR IMPLEMENTING DENTAL IMPLANTS

(71) Applicant: GST Ltd., West Orange, NJ (US)

(72) Inventors: Daniel SANDERS, Ra'anana (IL); Ben Zion Spector, Tel Mond (IL)

(21) Appl. No.: 14/778,335

(22) PCT Filed: Mar. 14, 2014
(86) PCT No.: PCT/IB14/59833

§ 371 Date: Sep. 18, 2015

(30) Foreign Application Priority Data
Mar. 18, 2013 (GB) 1304950.7

(51) Int. Cl. A61C 1/08; A61C 8/00

(52) U.S. Cl. CPC A61C 1/084; A61C 8/0089

(57) ABSTRACT

A system, apparatus, device, tools, kit and method is provided for the preparation of the jawbone and insertion of dental implants. The apparatus includes a universal and reusable clamping device and removable components for the clamp which allow for precision surgical preparation and implantation of dental implants into the jawbone. According to some embodiments, an apparatus is provided that includes a platform; one or more frames connected to the platform, wherein the frames include a clamp arm that extend to opposing sides of the bone; and one or more fixation cleats on each arm; wherein the apparatus includes one or more features for positioning the platform, for changing a position of the platform, for changing an angle of a component of the platform or any combination thereof, following the securing of the clamp arms to the bone and prior to the procedure.

### FIELD OF THE INVENTION

The present invention relates generally to dental implants and more particularly to an improved means and method for the preparation and insertion of dental implants.

### BACKGROUND OF THE INVENTION

A dental implant is an artificial prosthesis normally comprised of a single cylindrical component to replace the missing root structure of a natural tooth that has been lost. This standard implant is typically inserted into the jawbone by threading or screwing it into a prepared hollowed out bony site in the jawbone called in the field an osteotomy. The prepared osteotomy typically has a diameter that corresponds to the body dimensions of the implant without its threads and the threads of the implant engage (self-tap) the vertical inner walls of the osteotomy as it is screwed into place. The implant typically remains buried in the bone (endosseous) for a period of time to allow for “osseo-integration” or the growth and adhesion of natural bone around all the external surfaces of the implant, securing and stabilizing it in place so that it can withstand load forces. This cylindrical implant typically contains down its internal center a machined threaded internal hollow sleeve or bore that allows the dental practitioner upon later surgical exposure of the head or top (coronal) section of the cylindrical implant to screw into place a machined screw-in abutment (either with an integral screw on its inferior aspect or a separate connector screw which threads through a center hollow sleeve or bore of the abutment). The abutment, which extends into the oral cavity, is then utilized by the dentist to fabricate a single fixed prosthesis (crown), a multiple fixed prosthesis (dental bridges-multiple crowns connected to each other) in the case of adjacent multiple implants, or can take the form of a fixed prosthesis (over-denture bar prosthesis) to anchor a removable prosthesis such as a permanent denture, using techniques that are widely known in the dental field.

The upper and lower jaws are made up of a narrow strip of softer, spongy, alveolar bone sandwiched between two thin outer hard cortical plates of bone. In the posterior regions the entire width (cheek to tongue or buccal-lingual) of the jawbones is typically only 5 to 7 millimeters thick. The average interdental (anterior-posterior length between the teeth) space remaining when a molar tooth is lost (missing tooth space) is typically 10 to 12 millimeters long. The vertical depth of alveolar bone present where the tooth was lost can be as little as 5 to 10 millimeters before one encounters either the maxillary sinus space (in the upper jaw) and the inferior alveolar nerve (in the lower jaw).

To allow for a proper volume or thickness of jaw bone between the implant and the adjacent teeth so as to allow for a proper blood supply and health of the bone between the implant and the adjacent teeth, it has been accepted in the dental field to maintain a minimum distance of 1.5 to 2 millimeters between the implant and the adjacent teeth on either side of the implant and 1.5 to 3 millimeters between adjacent multiple implants.

This means that the target bone site for the proper placement of a dental implant is very limited and requires the practitioner who wishes to place dental implants safely to exercise considerable care performing the implant procedure after first having acquired a high degree of skill level and clinical experience. This becomes even more difficult for the practitioner when attempting to place multiple dental implants in the same jawbone.

Dental implants are typically placed using the following two surgical techniques: 1. Delayed technique: the unsalvageable tooth is extracted and the entire root socket(s) are allowed to heal with bone filling the void(s) over several months. Once this healing process has been completed, the practitioner opens the gum and drills into the bone to create the osteotomy (bone preparation) to allow for the insertion of the dental implant. 2. Immediate Extraction-Immediate Implant technique: At the same visit, the practitioner extracts the unsalvageable tooth and immediately inserts the dental implant into the fresh root socket voids or using a drill modifies this root socket or drills a new hole and places the implant into it. In the case of a molar tooth extraction the practitioner is left with multiple proximal root socket voids in the jawbone (where the multiple natural roots used to be) and an oval or rhomboid distal void (where the root trunk used to be).

Both surgical techniques require the sequential use of a series of increasing diameter and or length bone drills to properly prepare the osteotomy and so allow for the insertion of the dental implant. This is required in order to safely remove bone tissue in a gradient manner so as not to overheat the surrounding bone as would invariably occur if the largest diameter and length bone drill was used initially instead of the above described drilling protocol.

It is well established medical fact that overheating bone tissue is highly destructive to surrounding bone tissue and leads invariably to necrosis of bone tissue, a highly undesirable outcome.

The vast majority of dental implants are surgically inserted by the dental practitioner into the jawbones of the patient using the above two described surgical techniques in a free-hand manner (i.e. without the aid of any guidance system). As described above, this means that the dental practitioner in order to safely place dental implants relies solely on his/her skill level acquired through his experience, his latent natural talent, and his diligent exercise of care throughout the procedure. This required exercise of care and surgical skill level defined above applies both to both phases of the implantation procedure; namely: the bone preparation (osteotomy) and the subsequent insertion (implantation) of the dental implant into said bone preparation.

It will be appreciated that if the practitioner errs to even a relatively slight degree of 1-2 mm in any straight or angled direction (depth or position) while preparing the osteotomy and while inserting the implant into said bone preparation, s/he risks damaging sensitive anatomical structures as well as ending up with an implant placed in a non-optimal position in relation to the adjacent and opposing teeth and the final dental prosthesis placed onto the implant which will be used for functional biting and chewing and which relies on the implant for structural load support. The dental prosthesis will be secured to the implant once the implant has osseo-integrated (bone having grown in intimate contact around the exterior surface of the implant so that it is now stable). As mentioned above, it will be further appreciated that the required accuracy and precision described above is compounded when multiple implants are placed in the same patient.

In order to reduce the above skill requirements of the dental practitioner, surgical guided stents have in recent years begun to be used in the field in a limited fashion. Such stents are custom-made for each patient (discarded after a single use) and are fabricated using elaborate imaging equipment that has been wedded to sophisticated three dimensional software computer programs and which requires additional specialized dental laboratory fabrication to produce said stent.

This process is both time-consuming and expensive for the dental practitioner in terms of delay of delivery of treatment to the patient, fees to the laboratory, and the costs of the imaging and software licenses. As the stent is custom made for each patient these costs must be repeated for each patient.

The stent is usually made of acrylic materials and is custom shaped to closely conform to the alveolar ridges of the particular patient for whom they are to be placed in, in order to assure an intimate and accurate fit of the stent to the patient's mouth. Single or multiple hollow metal drill guide tubes are incorporated into the body of the stent at the location(s) of the intended implant target bone site(s).

It will be appreciated that these drill guide tubes only provide a location and angle for the practitioner. In order to limit or control the vertical drilling depth, they must be used in conjunction with multiple hand-held instruments that have hollow rings of varying diameters at their working ends and whose rings have circumferential limiting flanges that act as a stop limit in regards to the vertical depth of the bone drill when said bone drill is inserted into it.

The varying diameters of the hollow rings of the hand-held instruments, described above, correspond to varying diameters (of the previously described) sequentially used bone drills that are used to prepare the osteotomy at the target bone site.

In order to secure a surgical stent to the patient's jawbone, multiple pre-drilled holes are incorporated into the stent on the buccal (cheek-side) side wall of the alveolar ridge in a plane that is perpendicular to the crest of the alveolar ridge. Multiple holes are then drilled into the side wall of the buccal surfaces of the jawbone of the patient by the practitioner through said pre-drilled stem holes and metal securing pins are screwed or tapped into these holes to secure the stent to the jawbone. It can be appreciated that this required method for surgically securing the stent is quite invasive to the patient and results in significant post-operative pain and healing.

The above stents are normally placed onto the jawbone after surgical incisions are made to the gum tissue and reflection of the gum tissue has been performed, though some now advocate their use without prior reflecting of the gum tissue.

There is varying thickness of the gum tissue overlying the alveolar ridges in different patients so that reflecting the gum tissue prior to placing the stent onto the alveolar ridge is desirable as this allows for more accurate positioning of the stent directly onto the coronal bone surface of the alveolar ridge.

The circumferential outer lip of the embedded ring tubes of the stents can also be used as a limiting flange to control the vertical depth to which the implant is screwed/threaded into the osteotomy.

It will be obvious that a guidance system that does not require a custom-made surgical stent for each patient yet allows for similar or improved guided drilling and insertion of dental implants would be most advantageous.

### SUMMARY OF THE INVENTION

In accordance with some embodiments, a one time or reusable universal implanting apparatus is provided which comprises a surgical clamp that contains an outer frame, with individually adjustable positioning elements, that clamps and secures itself directly onto the bone or onto the gums and bone and a separate and affix-able inner frame to said outer frame whose position and orientation is separately adjustable from the outer frame and which allows for the securing of separate bone drilling and implant insertion guidance components to the inner frame element of the surgical clamp apparatus.

According to some embodiments, an apparatus is provided that comprises: a platform suitable for being positioned over a bone and maintained in position for a procedure including preparing a bone for an implant and/or implanting an implant into a bone; one or more frames connected to the platform, wherein the one or more frames includes clamp arms that extend to opposing sides of the bone; one or more fixation cleats on each arm, wherein each fixation cleat has a tip suitable for penetrating into a bone and/or gum tissue on the opposing sides of the bone so that the frame is secured to the bone during the procedure; one or more means for adjusting the position of the each fixation cleats for securing the clamp arms to the bone prior to and during the procedure and for removing the clamp arms from the bone after the procedure; wherein the apparatus includes one or more features for positioning the platform, for changing a position of the platform, for changing an angle of a component of the platform or any combination thereof, following the securing of the clamp arms to the bone and prior to the procedure.

In further embodiments, the bone is a jaw bone, and the procedure includes preparing a dental osteotomy and/or implanting a dental implant into a jaw bone.

In further embodiments, at least a portion of the platform includes one or more features for changing an angle of the platform relative to the bone, so that the apparatus can be used for preparing one or more dental osteotomies optionally having bores with different angles.

In further embodiments, at least a portion of the platform includes one or more features for changing the direction of an angle of the platform relative to the bone, so that the apparatus can be used for preparing one or more dental osteotomies having bores with different angles and different directions of each angles.

In further embodiments, at least a portion of the platform includes one or more features for changing the effective drilling height of the platform relative to the bone, so that the apparatus can be used for preparing two osteotomies having bores of different depths.

In further embodiments, the arms of the frame have an upper region that extend above the crestal height and the occlusal plane of the teeth, wherein the upper region of the arms have a plurality of bore holes and are connected by one or more arm connection screws extending through a bore hole of each arm and by one or more arm guide pins extending through a bore hole of each arm, wherein the bore holes are aligned so that the arms are maintained in a generally parallel relationship.

In further embodiments, the platform is connected to an inner frame, the inner frame has an upper portion, wherein the upper portion of the inner frame has bore holes for receiving the arm guide pins and the arm connection screw, wherein the bore holes of the upper portion of the inner frame have one or more features for securing the inner frame in a fixed position relative to the arm connection screws and the arm guide pins.

In further embodiments, the arm connection screw is a left/right screw so that both of the arms of the outer frame can be simultaneously and/or equally moved towards or away from the platform.

In further embodiments, the platform includes a lower guidance platform and an upper guidance platform.

In further embodiments, the platform includes a swivel nut positioned between the lower guidance platform and the upper guidance platform.

In further embodiments, the swivel nut has a bore hole extending that length of the swivel nut that is internally threaded, the platform includes an internally threaded guide ring locking nut and a drill guide ring, wherein the drill guide ring is generally cylindrical with a bore through the length for guiding a drill bit and the drill guide ring has an externally threaded outer surface for connecting the locking nut and the swivel nut.

In further embodiments, the apparatus includes a screw that extends from one of the arms of the outer frame to the inner frame for adjusting the relative position of the outer frame with respect to the inner frame in the buccal to lingual direction.

In further embodiments, the apparatus includes a screw for locking the position of the inner frame relative to the position of the two arms of the outer frame

In further embodiments, the apparatus includes one or more screws for positioning and locking the platform in the anterior to posterior axis relative to the inner frame, relative to the outer frame, or both.

In further embodiments, the apparatus is sufficiently adjustable so that it can be used for implanting implants in a plurality of patients.

In further embodiments, the apparatus is formed of materials capable of being sterilized after use in preparing an osteotomy so that the apparatus can be employed in an osteotomy for a different patient.

In further embodiments, each arm of the outer frame has internally threaded bore holes for each of the cleats so that the each of the cleats can be screwed individually against the gum, and the arm connection screw has a knob for screwing the arms together so that the cleats can evenly penetrate the gum tissue and/or the bone independent of the curvature of the gum tissue and/or bone.

In further embodiments, the apparatus is capable of preparing a vertical osteotomy and is also capable of preparing an osteotomy at an angle of about 1° or more from the vertical axis.

In further embodiments, the apparatus is capable of preparing an osteotomy at an angle of about 1° or more from the vertical axis and in a full 360° directional arc of the horizontal axis.

In further embodiments, the upper and lower guide platforms incorporate internal irrigation channels for directing irrigation fluid into the implanting bone site.

According to some embodiments, a process is provided that comprises the steps of: clamping a dental implantation apparatus to a jawbone, wherein the dental implantation apparatus includes a platform for guiding one or more tools for preparing an osteotomy and/or for implanting a dental implant into a jawbone; adjusting the position of the platform relative to the jawbone after the apparatus has been attached to the jawbone; and maintaining the position of the platform while performing one or more steps of preparing an osteotomy and/or implanting a dental implant.

According to some embodiments, the step of adjusting includes a step of adjusting one or any combinations of the following: a) adjusting the buccal to lingual position of the platform; b) adjusting the tilt angle of at least a portion of the platform relative to the vertical axis; c) adjusting the anterior to posterior position of the platform; or d) adjusting the direction of the projection of the tilt angle of the at least a portion of the platform onto the plane perpendicular to the vertical axis in a full 360° range of motion of the horizontal axis.

According to some embodiments, the dental implant apparatus includes an outer frame having two arms each having a lower portion that extends along opposing sides of a jawbone, and the apparatus includes a plurality of cleats protruding from each arm of the frame, and the step of clamping the apparatus includes inserting and engaging the each one of the cleats individually into gum tissue and/or into the hone.

According to some embodiments, the process includes a step of measuring a distance between a portion of the platform and the crestal region of the jawbone for calibrating the depth for a step of preparing an osteotomy, wherein the step of measuring occurs after a step of adjusting the position of the platform.

According to some embodiments, the process includes a step of measuring the depth of an osteotomy (e.g., relative to a portion of the platform) for calibrating an insertion depth for inserting an implant, wherein the step of measuring a depth occurs after a step of adjusting the position of the platform.

According to some embodiments, the process is a process of implanting an implant immediately following the extraction of a tooth, wherein the process includes one or any combination of the following steps: a) inserting an adjustable extraction socket gauge into a fresh extraction socket and measuring the depth of the socket; b) Calibrating a drill bit and/or an implant driver based on a measured depth of a socket (e.g., using a Calibration device); c) adjusting a drill guide ring assembly to a desired position including desired angle, to a desired direction, a desired depth, or any combination thereof, and locking this position; d) inserting a Calibrated drill bit and/or bushings into a drill guide ring to prepare an osteotomy having an including a desired angle, to a desired direction, a desired depth or any combination thereof; or e) inserting a Calibrated implant driver into a guide ring (e.g., a drill guide ring) and installing an implant at a desired angle, a desired direction, a desired depth, or any combination thereof.

According to some embodiments, the process comprises one or any combination of the following steps: a) extracting a tooth to form a socket; b) waiting for some or all of the socket to fill with bone; c) Calibrating a drill bit, an implant driver, an adjustable gum thickness gauge, or any combination therefor with a desired drill depth; d) securing a dental implant apparatus to a jaw bone at or near a dental implant site; e) adjusting a drill guide ring assembly to a desired position including a desired angle and/or a desired direction and locking this desired position; f) inserting the Calibrated gum thickness gauge into a drill guide ring, screwing down the gum thickness gauge until its tip penetrates the gum and rests on the bone of the target implant site, and remove the gum thickness gauge from drill guide ring, so that the guide ring is calibrated to drill to a desired drill depth; g) insert one or more drill bits and/or bushings with a desired drill depth into the drill guide ring for completing an osteotomy, wherein the drill bit, the head of the handpiece, and/or the bushing attached to the drill bit provide a limiting flange when inserted into the drill guide ring; or h) inserting a Calibrated implant driver connected to an implant into the drill guide ring, and screw down the implant with an implant driver into the osteotomy.

According to some embodiments, the process includes unclamping or otherwise removing the apparatus from the jawbone.

According to some embodiments, the process includes a step of sterilizing some or all of the apparatus and a step of using the sterilized components for implanting an implant in a different patient.

According to some embodiments, the process includes a step of preparing a second osteotomy at a different angle, a different direction, a different depth or any combination thereof from the first osteotomy in either the same patient or in a different patient, using the same apparatus (e.g., using the same platform).

According to some embodiments, a calibration device is provided, comprising: a top portion having one or more bore holes for receiving one or more gauges; a bottom portion that is spaced apart from the top portion; wherein the spacing between the top and bottom portion is adjustable; wherein the spacing between the top portion and the bottom portion can be set to a set position using a guide pin having a limiting flange ring for contacting the bottom portion, wherein the spacing is capable of being set by placing a gauge through one of the bore holes of the top portion so that the gauge just touches the top surface of the bottom portion, wherein the bottom portion has a bore hole for receiving a drill bit and/or an extraction socket gauge so that the drill bit or extraction socket gauge extends to the upper portion; and wherein the upper portion has calibration markings for calibrating the drill bit or the extraction socket gauge; so that the calibration apparatus can be used for drilling an osteotomy having a predetermined depth, and or for inserting an implant into an osteotomy to a predetermined depth.

According to some embodiments, the device includes a bore for receiving an adjustable bit from an extraction socket gauge, a bore for receiving an adjustable bit from a gum thickness gauge, and a bore for receiving an adjustable bit from an implant driver.

According to some embodiments, an extraction socket gauge is provided, with an adjustable sliding center measuring bit that can be locked at various lengths relative to the body of the extraction socket gauge for the accurate measuring of an extraction socket.

According to some embodiments, an extraction socket gauge is provided with an adjustable sliding center measuring bit that can be locked at various lengths relative to the body of the extraction socket gauge for insertion into a drill guide ring, and calibrating the drill depth of an osteotomy.

According to some embodiments, a gum thickness gauge is provided with an adjustable sliding center measuring bit that can be locked at various lengths relative to the body of the gum thickness gauge for the accurate measuring of the thickness of the gum tissue overlying the alveolar crest of a jawbone.

According to some embodiments, a gum thickness gauge is provided with an adjustable sliding center measuring bit that can be locked at various lengths relative to the body of the gum thickness gauge for insertion into a drill guide ring, and calibrating the drill depth of an osteotomy.

According to some embodiments, an implant driver tool is provided with an adjustable sliding center measuring bit that can be locked at various lengths relative to the body of the implant driver tool for insertion into a drill guide ring, and calibrating the depth the implant is inserted into the osteotomy.

According to some embodiments, a kit is provided that includes any combination of two or more of an implant driver tool, a gum thickness gauge, an extraction socket gauge, or a calibration device.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIGS. 1A-1D show different perspectives of a surgical implant clamping apparatus, according to some embodiments;

FIGS. 2A-2E are graphical illustrations of some components of a surgical implant clamping apparatus, according to some embodiments;

FIGS. 3A-3I show different perspectives of graphical illustrations of a guidance platform of a surgical implant clamping apparatus;

FIGS. 4A-4H are graphical illustrations of various elements related to the guidance position locking mechanism, according to some embodiments;

FIGS. 5A-5C are graphical illustrations of the guidance position locking mechanism being used with a surgical implant clamping apparatus, according to some embodiments;

FIGS. 6A-6H are graphical illustrations of various components adapted for use with a surgical implant clamping apparatus, according to some embodiments;

FIGS. 7A-7G are graphical illustrations of various calibration related components adapted for use with a surgical implant clamping apparatus, according to some embodiments;

FIGS. 8A-8E are graphical illustrations of calibration apparatus tools adapted for use with a surgical implant clamping apparatus, according to some embodiments;

FIGS. 9A-9C are graphical illustrations of some examples of the calibration apparatus being setup for treatment using a surgical implant clamping apparatus, according to some embodiments;

FIGS. 10A-10E are further graphical illustrations of calibration components for use with a surgical implant clamping apparatus, according to some embodiments;

FIGS. 11A-11F are graphical illustrations of a mandible being setup for a delayed surgical technique implantation treatment using a surgical implant clamping apparatus, according to some embodiments;

FIGS. 12A-12F are further graphical illustrations of a mandible being setup for an immediate surgical technique implantation treatment using a surgical implant clamping apparatus, according to some embodiments;

FIG. 13 is a flow chart that describes a series of operations or processes that may be implemented to prepare a jaw bone for immediate placement of a dental implant, according to some embodiments; and

FIG. 14 is a flow chart that describes a series of operations or processes that may be implemented to prepare a jaw bone for delayed placement of a dental implant, according to some embodiments.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

Embodiments of the present invention enable dental implant treatments using one time or reusable surgical clamp apparatus and guidance system. Means and methods are herein provided for the preparation and insertion into bony tissue of standard implants, and for positioning the apparatus, for changing a position of the apparatus, for changing an angle of a component of the apparatus or any combination thereof, following the securing of the clamp apparatus to the bone and prior to the procedure, such that the bone/gum preparation and implant insertion may be conducted by a practitioner with precise guidance tools to enable enhanced accuracy and safety. According to some embodiments, the adjusting of the apparatus to a patient's jawbone may include adjusting the buccal to lingual position of the apparatus, adjusting the tilt angle of at least a portion of the apparatus relative to the vertical axis, adjusting the anterior to posterior position of the apparatus; and/or adjusting the direction of the projection of the tilt angle and the degree of tilt angle from the vertical axis of the at least a portion of the platform onto the plane perpendicular to the vertical axis. In such dental implant treatments, whether for immediate or delayed surgical implantation treatments, the precision positioned and secured guidance system is able to provide the practitioner with the necessary depth and angle measurement to enable optimized and safe preparation and insertion of implants.

The clamp apparatus may come in several standard sizes so as to allow for matching a particular size clamp apparatus to better fit inside a particular patient's mouth and clamp properly to different size jawbones.

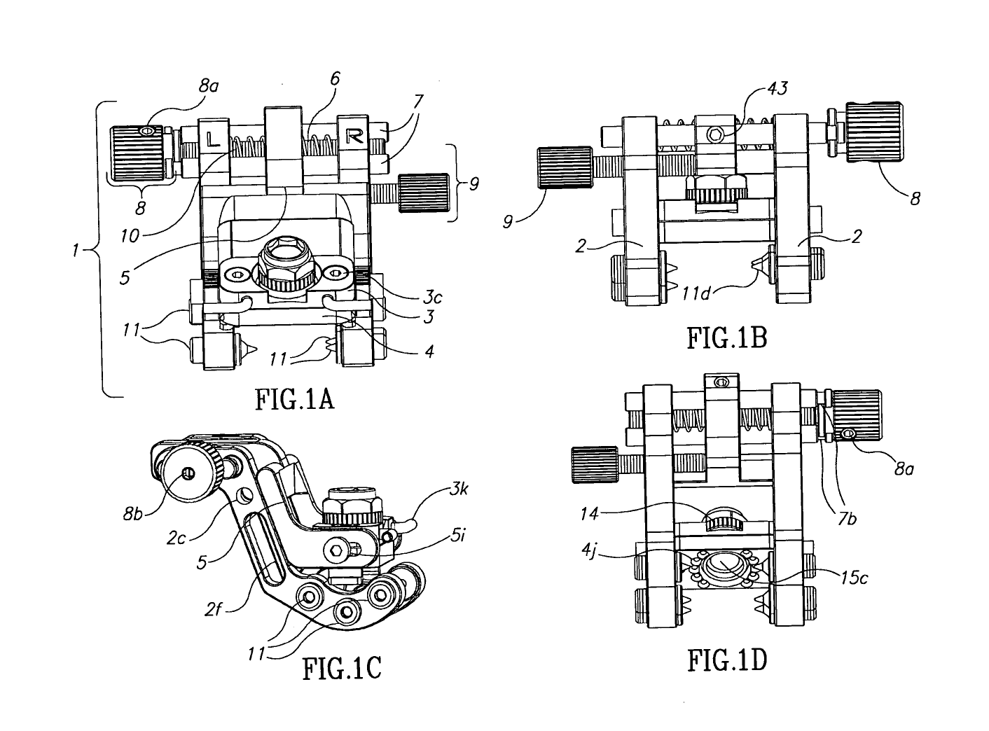

FIGS. 1A-1D show different perspectives and components of an example of a surgical implant clamping apparatus 1, according to some embodiments. The surgical clamp apparatus is fabricated from sturdy materials that are bio-compatible with living tissue and fluids can be cleaned and repeatedly sterilized using known methods in the field. These may include various metal alloys such as different types of stainless steel or different types of titanium or titanium alloys. These may also include various surgical grade plastic materials or other suitable materials.

Surgical clamp apparatus 1 may include a platform suitable for being positioned over a bone and maintained in position for a procedure including preparing a bone for an implant and/or implanting an implant into a bone, the platform being coupled to an outer frame, which is made up from two surgical clamp arms 2, connected by a right/left threaded bolt 6, surrounded by right/left bolt springs 10, and an inner frame 5, to enable the two clamp arms to be closed and opened simultaneously and optionally to the same degree along the buccal to lingual axis.

In some embodiments, the right and left clamp arms 2 are relatively “s” shaped with a relatively vertical central segment connected one either side to an upper and lower relatively horizontal segment and each arm matching the other in regards to dimensions. Of course, other forms may be used. Surgical clamp apparatus 1 may include an upper guide platform 3 and a lower guide platform 4, for supporting surgical and implant guides. Also seen in these figures are right/left bolt adjusting knob 8 and guide plane adjusting knob 9.

In some embodiments, inner frame 5 may consist of a single “s” shaped component which mirrors the “s” shape of the right and left clamp arms of the outer frame. Of course, other forms may be used. The inner frame's upper horizontal segment contains three bore holes for the insertion of the two-guide pins and the threaded center right/left bolt. The inner frame is assembled onto the—two guide pins and right/left threaded bolt between the right and left clamp arms of the outer frame. Inner frame 5 may have a horizontal and vertical segment in the shape of a “t” bar emerging from its upper horizontal segment which extends to the inner borders of both the right and left clamp arms. In some embodiments, the lower right and left horizontal segments of the inner frame serves as an outer frame for the insertion of the guide platforms and guidance position locking mechanism. In some embodiments, the center right/left threaded bolt 6 may contain two spring coils around its respective right and left threaded segments (between either side of the inner frame and the right or left clamp arms) to create a spring-loaded action to the movement of the inner frame along the guide pins and threaded bolt.

In some embodiments, the upper segment of each clamp arm contains three bore holes where the two outer ones are smooth and the center bore hole is internally threaded. The two outer bore holes are machined to allow for the insertion of a guide pin into each bore hole. The center bore hole is machined to allow for the insertion of a right/left threaded bolt with a knurled knob on one of its ends. It will be appreciated that the center right/left threaded bolt will be inserted so that the right directional threads of the bolt insert into the center bore hole of the right clamp arm and the left directional threads of the bolt insert into the center bore hole of the left clamp arm.

Such an assembly of the above parts allows for the two clamp arms to be closed and opened simultaneously (brought closer or further to each other) in a symmetrically even manner when the knurled knob (with its two locking nuts) is turned either clockwise or counter-clockwise. To further enhance this symmetrically even opening/closing mechanism the two outer guide pins have limiting heads which face and engage a circumferential groove on the knurled knob of the center right/left threaded bolt.

The relatively vertical segment of each arm may contains an internally threaded bore hole for the insertion of a set screw with a knob that allows for the adjustment along the buccal to lingual axis (cheek to tongue) of the inner frame when the inner frame is attached to the other frame. The lower horizontal segment of each clamp arm may contain multiple internally threaded bore holes which may be positioned in various positions relative to each other in this clamp arm segment.

Each arm may include one or more fixation cleats with tips suitable for penetrating into a bone and/or gum tissue on the opposing sides of the bone so that the frame is secured to the bone during the procedure. The multiple internally threaded bore holes described above accept the insertion of variously designed individually adjustable fixation cleats 11 whose pointed tips (of various shaped design) engage and penetrate a short distance either directly into the side bony walls (buccal and lingual plates) of the alveolar ridges or through both the gums tissue overlying the ridges and the bony ridges when the clamp arms are tightened towards each other, by rotating the knurled knob of the center right/left bolt, thereby stabilizing and securing the clamp apparatus at multiple locations on both the buccal and lingual aspects of the patient's gums and/or jawbone.

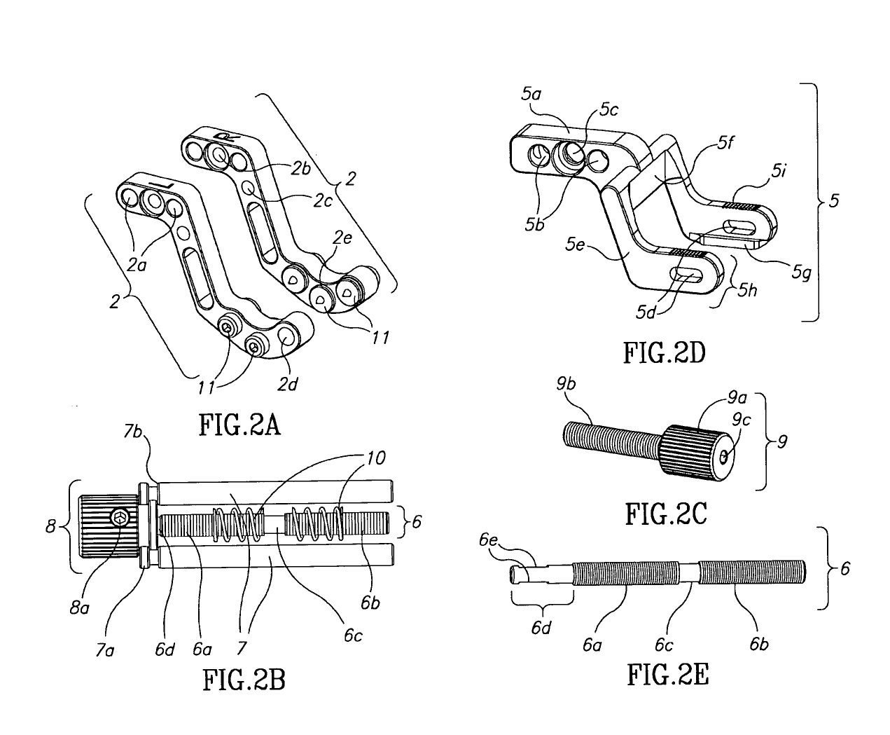

FIGS. 2A-2E are graphical illustrations of some components of the surgical implant clamping apparatus 1, according to some embodiments. As can be seen in FIG. 2A, surgical clamp arms 2 may include a bore hole for guide pins 2a, a bore hole for right/left bolt 2b, a bore hole for guide plane elements adjusting knob 2c, bore holes for surgical fixation cleats 2d, and a clamp arm cleat holder segment 2e, for supporting the multiple fixation cleats, designed to engage the gum and or bony walls in a securing fashion.

As can be seen in FIG. 2B, inner frame 5 may include an inner frame upper bar 5a, an inner frame pin bore 5b, an inner frame right/left bolt bore 5c, an inner frame oval bore 5d, for allowing lateral platform movement, an inner frame relatively vertical element 5e, an inner frame cross member 5f, an inner frame shelf 5g, an inner frame arm 5h with calibrated markings on its top surface 5i.

As can be seen in FIG. 2C, the right/left bolt 6 is enclosed in an adjusting knob 8 and a right/left bolt set screws 8a and right/left know bolt driver tool slot 8b, for turning the right/left threaded bolt 6. Right/left bolt 6 is surrounded by right/left bolt springs 10 and guide pins 7, which may include a guide pin head 7a, and a guide pin notch 7b.

As can be seen in FIG. 2D, inner frame adjusting knob 9 may include an inner frame knob head 9a, an inner frame knob threaded shaft 9b, and an inner frame knob adjusting slot 9c.

As can be seen in FIG. 2E, right/left threaded bolt 6 may include a left section of Right/Left bolt 6a, a right section of Right/Left bolt 6b, a center unthreaded section of Right/Left bolt 6c, an end section of Right/Left bolt 6d, and end section cut outs 6e for facilitating the securing of the adjusting knob 8 to this segment of the Right/Left bolt.

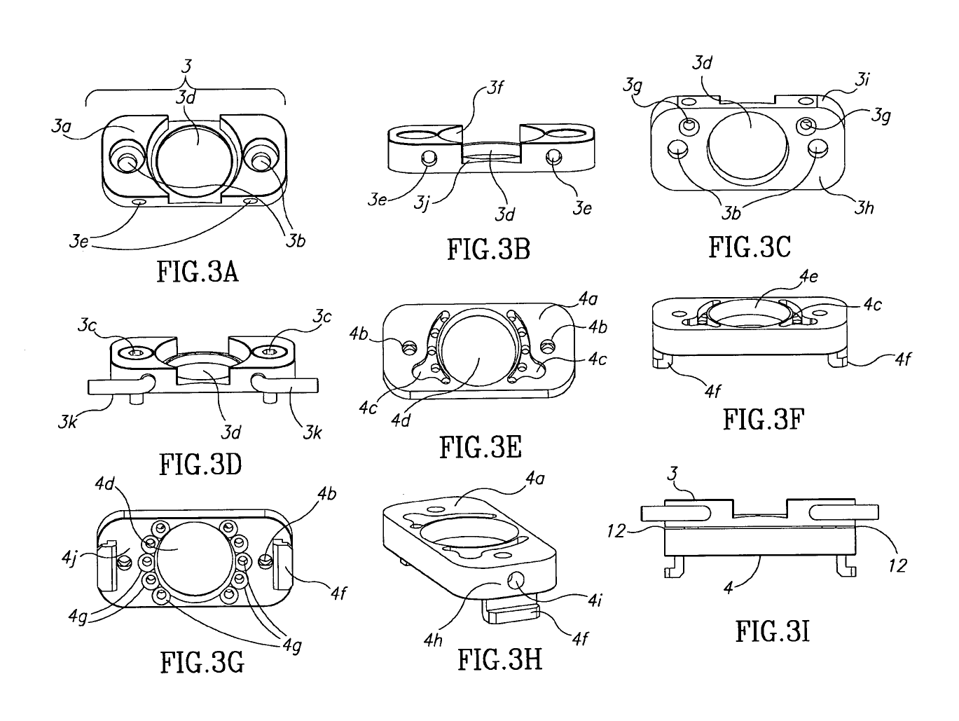

FIGS. 3A-3D show different perspectives of graphical illustrations of the upper guidance platform 3 of a surgical implant clamping apparatus, to enable precision bone preparation and implant delivery using standard implants. Surgical clamp apparatus 1 includes upper guide platform 3, which is supported by a lower guide platform 4 useful in implant preparation. Upper Guide Platform 3 may include a guide platform top surface 3a, an Upper Guide platform locking bore 3b, a Guide platform Locking screws 3c for Swivel nut 13, an Upper Guide platform center bore 3d, an Upper Guide platform irrigation tube bore 3e, an Upper Guide platform center bore with curved side walls 3f, an Upper Guide platform bottom irrigation bores 3g, an Upper Guide platform bottom surface 3h, an Upper Guide platform side wall 3i, an Upper Guide platform side wall cut out 3j, and an Upper Guide platform irrigation tube 3k, for delivering liquids to the treatment area.

FIGS. 3E-3H show different perspectives of graphical illustrations of the lower guide platform of a surgical implant clamping apparatus. Surgical clamp apparatus 1 includes a lower guide platform 4, for further supporting precision implant preparation, in association with upper platform 3. Lower guide platform 3 may include a Lower Guide platform top surface 4a, a Lower Guide platform bore 4b for Swivel nut 13 (not shown), a Lower Guide platform irrigation channels 4c, a Lower Guide platform center bore 4d, a Lower Guide platform curved side walls of center bore 4e, a Lower Guide platform shelf runner 4f, a Lower Guide platform bottom surface irrigation holes 4g, a Lower guide platform clamp arm side wall 4h, and a Lower Guide platform shelf locking nut bore 4i.

As can be seen in FIG. 3I, the upper and lower platforms may be coupled such that a gap 12 remains between them. Gap 12 is designed in order to enable swivel nut 13 to be swiveled or otherwise rotated or precisely positioned prior to locking engagement, as will be described below.

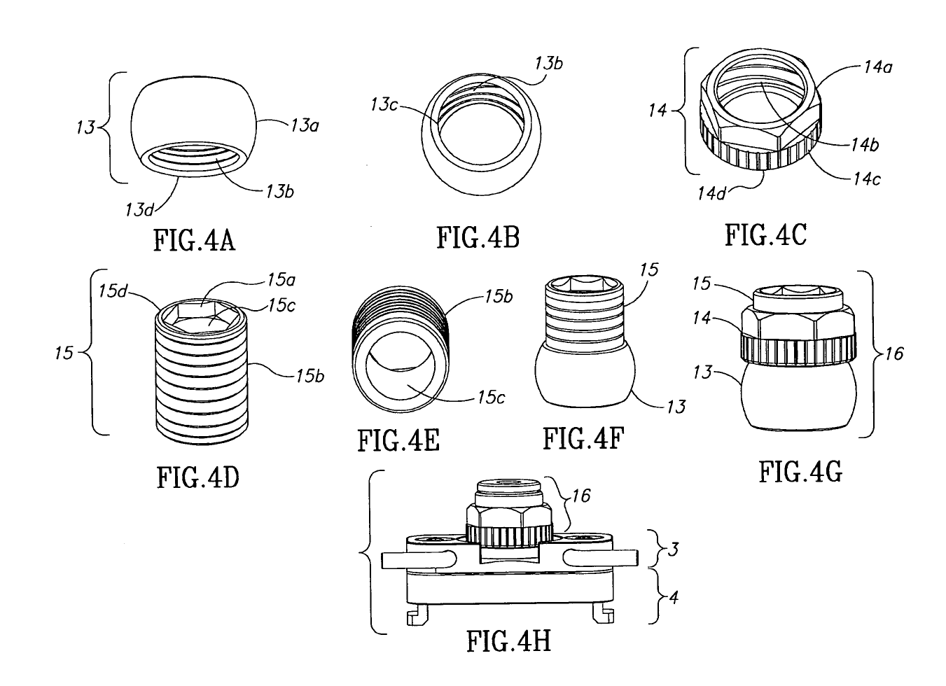

FIGS. 4A-4H are graphical illustrations of various components on the guidance position locking mechanism, to be used in association with the upper and lower guide platforms, according to some embodiments. As can be seen, the precision locking mechanism, hereinafter referred to as a drilling guide ring assembly 16, may include a swivel nut 13, a Drilling Guide Ring locking nut 14, and a Drilling Guide Ring 15.

As can be seen in FIGS. 4A-4B, Swivel nut 13 may include Swivel nut curved outer side walls 13a, Swivel nut threaded inner walls 13b, Swivel nut upper limiting flange 13c, and Swivel nut lower limiting flange 13d.

As can be seen in FIG. 4C, Drilling Guide Ring locking nut 14 may include Guide Ring locking nut upper adjusting element 14a, Guide Ring locking nut bore threaded inner side walls 14b, Guide Ring locking nut lower adjusting element 14b, and Guide Ring locking nut lower limiting flange 14d.

As can be seen in FIG. 4D-4G, Drilling Guide Ring 15 may include Drilling Guide Ring inner adjusting element 15a, Drilling Guide Ring threaded outer side walls 15b, Drilling Guide Ring bore inner walls 15c, and Drilling Guide Ring upper limiting flange 15d.

FIG. 4H shows the drilling guide ring assembly 16 engaged with upper and lower guide platforms, to enable precision securing of the drill guide members so as to enable secure and precise bone preparation and implant installation by a practitioner. In one example drilling guide ring assembly 16 engaged with upper and lower guide platforms may enable precision securing of the drill guide members so as to enable preparing a vertical osteotomy, and is also capable of preparing an osteotomy at an angle of about 1° or more from the vertical axis. In a further example, the swivel nut may be engaged with both the upper and lower guide platforms, with the gap allowing for swivel angles up to 15 degrees or more from the vertical “z” axis in full 360 degree circle range from the “z” axis. When at its optimal angle for drilling, the Swivel nut 13 may be locked in place, thereby establishing angular fixing, after tightening the Guide platform locking screws 3c between the upper 3 and lower 4 guide platforms. In some embodiments ring assembly 16 may be used to prepare one or more dental osteotomies optionally having bores with different angles.

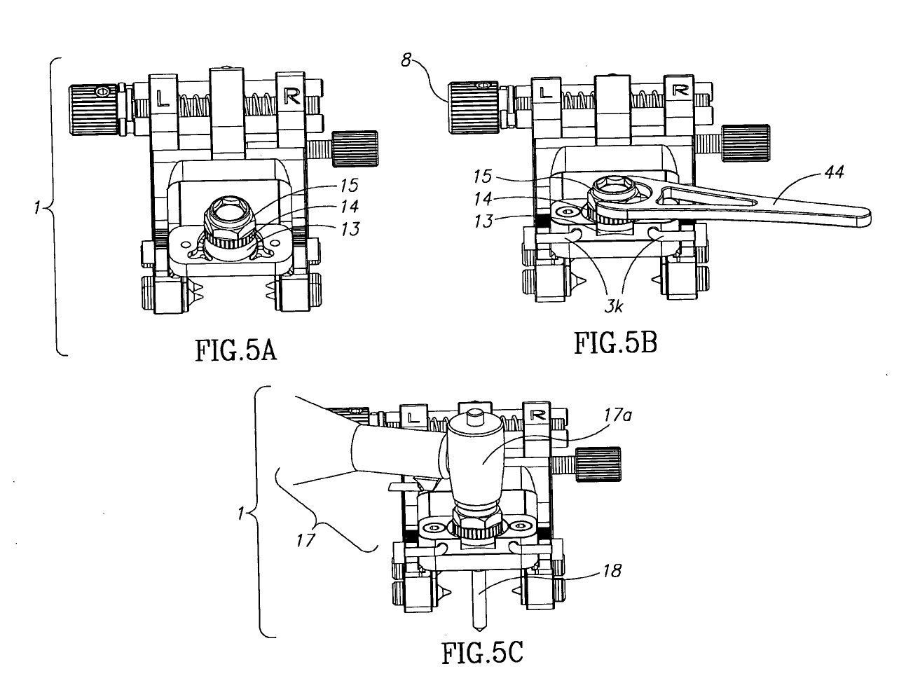

FIGS. 5A-5C show different phases and views wherein the drilling guide ring assembly 16 with its swivel nut 13, Drilling Guide Ring locking nut 14, and Drilling Guide Ring 15, is engaged with a surgical clamp apparatus 1, on the guide platforms. As can be seen in FIG. 5A, drilling guide ring assembly 16 is seated in lower platform 4 in platform center bore 4D. In FIG. 5B the drilling guide ring assembly 16 is seated in both the upper 3 and lower 4 guide platforms wherein is further illustrated a Drilling Guide Ring locking nut wrench 44. Nut wrench 44 may be used to tighten the drilling guide ring locking nut 14, when drilling guide ring assembly 16 is set up in the correct position, to secure the vertical position of the drilling guide ring 15. As can be seen in FIG. 5C, a standard or specialized Implant drill hand-piece attachment 17 may be used to continue the procedure, by using surgical clamp apparatus 1 to support the precision preparation and execution of implant treatment when the handpiece 17 with its attached drill bit 18 are fully inserted into the drilling guide ring assembly 16.

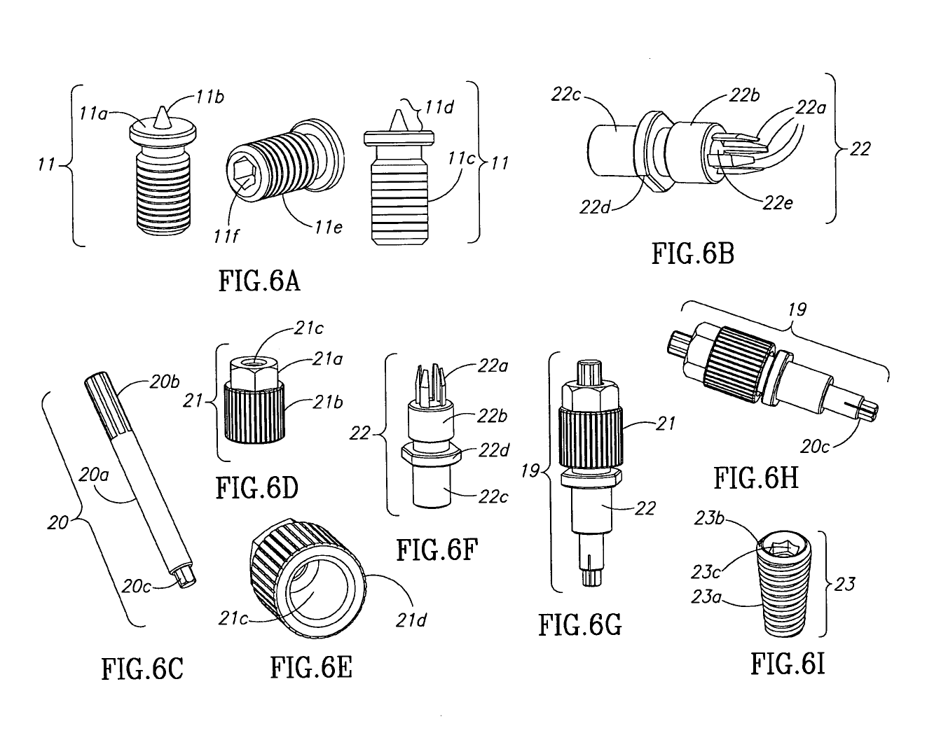

FIGS. 6A-6H are graphical illustrations of various components adapted for use with a surgical implant clamping apparatus, according to some embodiments. As can be seen in FIG. 6A, a fixation cleat 11 may include a Fixation cleat limiting face 11a, a Fixation cleat bone point 11b, a Fixation cleat neck 11c, a Fixation cleat gum/bone point 11d, Fixation cleat threaded shaft 11e, and a Fixation cleat adjusting slot 11f. It is appreciated that these configurations of the cleat may be modified to allow for curved surfaces of bone and or gums.

As can be seen in FIG. 6B, an Implant driver collet 22 of the Implant Driver 19 (not shown) is provided, which may include, for example an Implant driver collet clamping prongs 22a, an Implant driver collet clamping prongs head 22b, an Implant driver collet shaft 22c, an Implant driver collet shaft limiting flange 22d, and an Implant driver collet shaft bore 22e. As can be seen in FIG. 6C, the Implant Driver 19 (not shown) may include an Implant driver adjustable driver shaft element 20 that may include, for example, an Implant driver shaft 20a, an Implant driver adjustable driver shaft top section 20b, and an Implant driver flexing driver head 20c.

As can be seen in FIG. 6D, an Implant driver locking nut 21 is provided, which may include, for example, an Implant driver locking nut upper adjusting element 21a, an Implant driver locking nut lower adjusting element 21b, an Implant driver locking nut threaded bore 21c, and an Implant driver locking nut lower limiting flange 21d.

As can be seen in FIG. 6F, an alternative perspective of the Implant driver collet 22 is provided, which may include, for example, Implant driver collet clamping prongs 22a, an Implant driver collet clamping prongs head 22b, an Implant driver collet shaft 22c, an Implant driver collet shaft limiting flange 22d, and an Implant driver collet shaft bore 22e. As can be seen in FIG. 6E, Implant driver locking nut 21 is shown according to an alternative perspective, with Implant driver locking nut threaded bore 21c, and Implant driver locking nut lower limiting flange 21d.

As can be seen in FIG. 6G-6H, Adjustable implant driver 19 is shown, with engaged Implant driver locking nut 21 and Implant driver collet 22. Also shown is Implant driver flexing driver head 20c, for helping engage Dental Implant 23. As can be seen FIG. 61, dental implant 23 may include, for example, an Implant threaded outer side wall 23a, an Implant neck 23b, and an Implant threaded internal bore 23c.

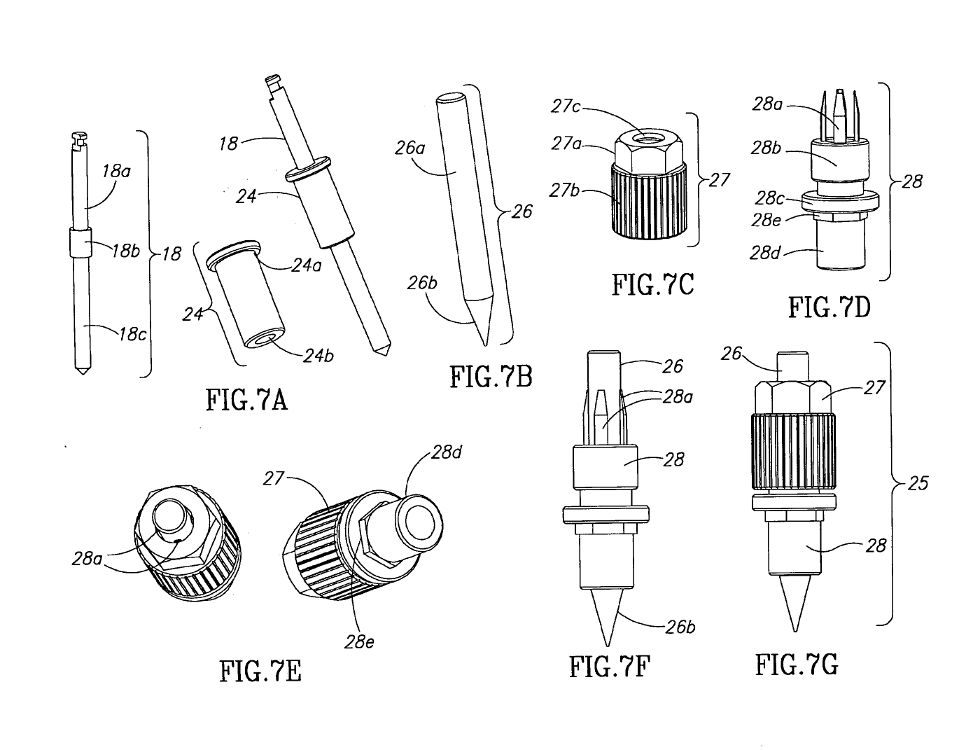

FIGS. 7A-7G are graphical illustrations of various calibration related components adapted for use with a surgical implant clamping apparatus, to help determine precise dimensions for bone preparation and implant installation, according to some embodiments. As can be seen in FIG. 7A, a Drill bit 18 is provided, which may include a Drill bit shank 18a, a Drill bit shank limiting flange 18b, a Drill bit cutting end 18c, and a Drill bit bushing 24.

As can be seen in FIG. 7B, a Gum thickness gauge inner shaft 26 is provided, for establishing gum thickness to enhance accuracy of bone drilling. Gum thickness gauge inner shaft 26 may include a Gum thickness gauge inner shaft main body 26a, and a Gum thickness gauge inner shaft probe element 26b.

As can be seen in FIG. 7C, a Gum thickness gauge locking nut 27 is provided, which may include a Gum thickness gauge locking nut upper adjusting element 27a, a Gum thickness gauge locking nut lower adjusting element 27b, and a Gum thickness gauge locking nut threaded bore 27c.

As can be seen in FIG. 7D, a Gum thickness gauge collet 28 is provided, to help set the gauge at a selected setting. Collet 28 may include, for example, a Gum thickness gauge collet clamping prongs 28a, a Gum thickness gauge collet clamping prongs head 28b, a Gum thickness gauge collet shaft limiting flange 28c, a Gum thickness gauge collet shaft 28d, and a Gum thickness gauge Drilling guide ring engaging element 28e. FIG. 7E shows an alternative perspective of gauge locking nut 27 engaged with gauge collet clamping prongs 28a. FIG. 7E also shows an alternative perspective of gauge locking nut 27 engaged with Gum thickness gauge collet shaft 28d and a Gum thickness gauge Drilling guide ring engaging element 28e.

FIG. 7F shows a coupling of Gum thickness gauge inner shaft 26 and Gum thickness gauge collet 28, using Gum thickness gauge collet clamping prongs 28a. Also seen is Gum thickness gauge inner shaft probe element 26b penetrating through the length of collet 28. FIG. 7G shows a coupling of perspective of the Adjustable gum thickness gauge 25, which includes a coupling of the Gum thickness gauge inner shaft 26, the Gum thickness gauge locking nut 27, and Gum thickness gauge collet 28.

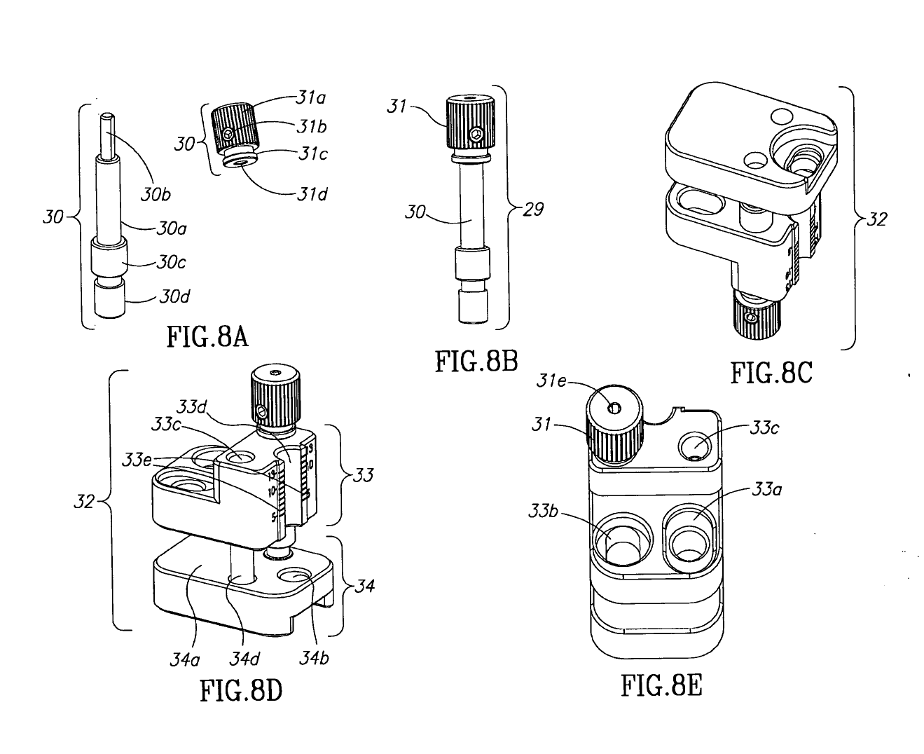

FIGS. 8A-8E are graphical illustrations of calibration apparatus tools adapted for use with a surgical implant clamping apparatus, according to some embodiments. As can be seen in FIGS. 8A-8B, a Pre-procedure Calibrating device guide pin shaft 30 is provided, which includes Calibrating device guide pin shaft body 30a, a Calibrating device guide pin knob engaging shaft 30b, a Calibrating device guide pin limiting flange ring 30c, and a Calibrating device guide pin screw element 30d. Further, a Calibrating device guide pin knob 31 is provided, which may include a Calibrating device guide pin knob outer side wall 31a, a Calibrating device guide pin knob locking screw 31b, a Calibrating device guide pin knob limiting flange 31c, and a Calibrating device guide pin knob bore 31d. FIG. 8B shows a Calibrating device adjustable guide pin 29, which includes the coupling of the pin shaft 30 and guide pin knob 31.

Calibrating device 32 is used to help calibrate a variety of treatment related instruments for enhanced safety and accuracy in a procedure. Calibrating device 32 may include, for example, Calibrating device upper element 33, which may include a Calibrating device upper element cut out bore for adjustable implant driver 33a, a Calibrating device upper element cut out bore for adjustable gum thickness gauge 33b, a Calibrating device upper element cut out bore for lower element guide pin 33c, a Calibrating device upper element cut out for drill bit or extraction socket gauge 33d, and a Calibrating device upper element cut out for drill bit or extraction socket gauge calibrating markings 33e. Calibrating device 32 may include, for example, a Calibrating device lower element 34, which may include Calibrating device lower element top surface 34a, a Calibrating device lower element bore 34b, a Calibrating device lower element cut out 34c, and a Calibrating device lower element guide pin 34d. FIG. 8E further shows guide pin knob 31 with a Calibrating device guide pin knob driver slot 31e. Further, Calibrating device upper element 33 shows a Calibrating device upper element cut out bore for adjustable implant driver 33a, a Calibrating device upper element cut out bore for adjustable gum thickness gauge 33b, a Calibrating device upper element cut out bore for lower element guide pin 33c, a Calibrating device upper element cut out for drill bit or extraction socket gauge 33d, and a Calibrating device upper element cut out for drill bit or extraction socket gauge calibrating markings 33e.

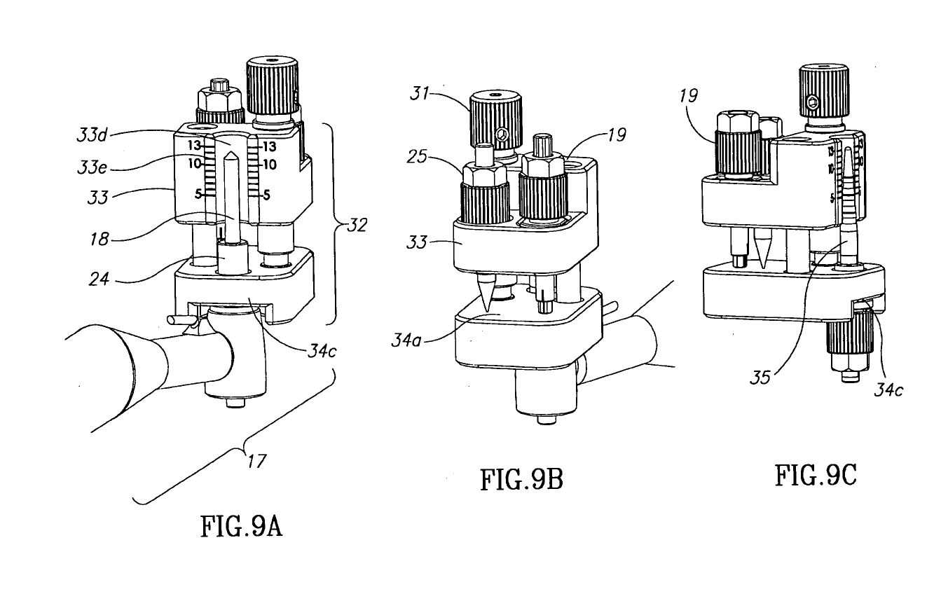

FIGS. 9A-9C are graphical illustrations of some examples of the calibration apparatus being setup for treatment using a surgical implant clamping apparatus, according to some embodiments. FIG. 9A shows an Implant drill handpiece attachment 17 coupled to Calibrating device 32, via Calibrating device lower element cut out 34c. As can be seen, Drill bit length can be selected in accordance with a practitioners professional opinion, for example, a drill bit length of choice for a treatment may be 13 mm for preparing an osteotomy whose depth is 13 mm. The drill bit is surrounded by a Drill bit bushing 24, to enable the Calibrating device to set the the drill bit at a selected length. Device 32 includes a Calibrating device upper element 33, which may include, for example, Calibrating device upper element cut out bore 33a for adjustable implant driver 19, a Calibrating device upper element cut out bore 33b for adjustable gum thickness gauge 25, a Calibrating device upper element cut out bore for lower element guide pin 33c, a Calibrating device upper element cut out 33d for drill bit 18 or extraction socket gauge 35, and a Calibrating device upper element calibrating markings 33e for calibrating either the drill bit 18 or extraction socket gauge 35.

FIG. 9B shows another perspective of Calibrating device 32, where an Adjustable implant driver 19 and an Adjustable gum thickness gauge 25 can be seen inserted and being positioned inside the Calibrating device upper element 33. Further, as can be seen, the respective driver and gauge penetrate though upper element 33 towards lower element 34 through the respective cut outs 33b and 33a of the Calibrating upper element 33. A Calibrating device guide pin knob 31 may be rotated to change the distance between the upper and lower elements, in accordance with the desired length for the drill bit 18. The inner shaft 20 of the Implant driver 19 and the inner shaft 26 of the gum thickness gauge can now be pushed down so as to be resting on Calibrating device lower element top surface 34a and in so doing calibrate both these tolls to the desired length previously set for the drill bit 18. FIG. 9C further shows the Extraction socket adjustable gauge 35 penetrating through the Calibrating device lower element cut out 34c from below the lower element so as to allow for the calibration of the Implant driver 19 to the length previously set for the Extraction socket adjustable gauge 35.

In further embodiments, Calibrating device 32 may include one or more features for changing the effective drilling height of the apparatus relative to the bone, so that the apparatus can be used for preparing two osteotomies having bores of different depths.

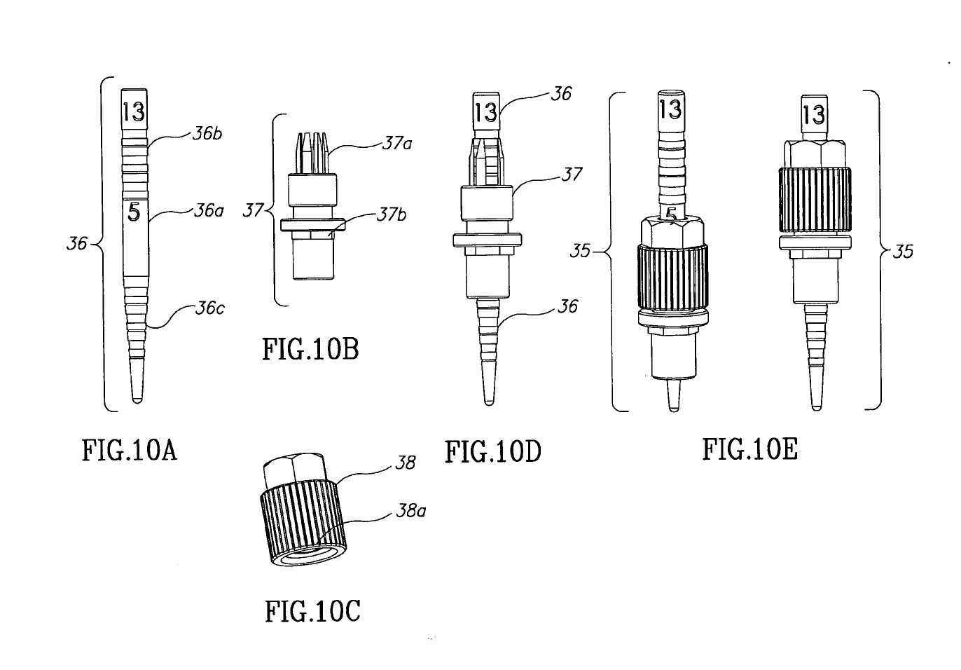

FIGS. 10A-10E are further graphical illustrations of calibration components for use with a surgical implant clamping apparatus, according to some embodiments. In FIG. 10A an Extraction socket gauge shaft element 36 is provided for the Extraction socket gauge 35 (not shown), which may include, for example, an Extraction socket gauge shaft body 36a, an Extraction socket gauge shaft upper calibrating section 36b, and an Extraction socket gauge shaft lower calibrating section 36c. In FIG. 10B an Extraction socket gauge collet 37 is shown, which may include, for example, Extraction socket gauge collet clamping prongs 37a, and Extraction socket gauge collet Drilling guide ring engaging element 37b. In FIG. 10C is shown an Extraction socket adjustable gauge locking nut 38, including an Extraction socket adjustable gauge locking nut bore 38a. FIG. 10D shows the coupled engagement of the Extraction socket gauge shaft element 36 and the Extraction socket gauge collet 37. FIG. 10E further shows different positions of the Extraction socket adjustable gauge 35, in accordance with different length settings.

In accordance with some embodiments, apparatus and methods are herein provided to enable Calibration of implant instruments outside the mouth, prior to the invasive treatment. For example, if a practitioner determines to use a drill bit set to 10 mm implant, Calibration apparatus knob 31 may be turned to set the upper and lower apparatus elements to be set at the appropriate distance in accordance with the desired drill bit length. In turn, other necessary tools, such as the Adjustable implant driver 19 and Adjustable gum thickness gauge 25 may be Calibrated in accordance with the drill bit settings described above. All such tools may be set at a desired height and lock by rotation of a locking nut, locking collet and shaft. For example, the Gum thickness depth Gauge inner shaft 26 of the Gum thickness depth gauge 25 may be placed at 10 mm in the Calibrating device 32 based on the length of the drill bit to be used for the preparation of the osteotomy. The Configured Gum thickness depth gauge 25 may then be removed from the calibration tool, and dropped into the Drilling guide ring 15. In some examples, a hex-type element 28e of the Gum thickness depth gauge 25 with limiting flange may be used to engage a matching hex slot 15a of the Drill guide ring 15. The pre-set length of probe 26a of the Gum thickness depth gauge 25 may be threaded down into the drill guide ring 15. The practitioner generally needs to screw the probe down until s/he feels the point at which the driver end penetrates through the gum and engages the bone. The Drill guide ring is now set to the depth for bone drilling to the predetermined depth desired (based on the Chosen drill bit length) exclusive of the gum thickness depth overlying the bone. This method of calibrating the Drill Guide ring 15 allows for the practitioner to compensate for the variable gum thickness in each patient and to enable the drilling to a depth of 10 mm in jaw bone regardless of the thickness of the gum tissue overlying the bone at the target implant site.

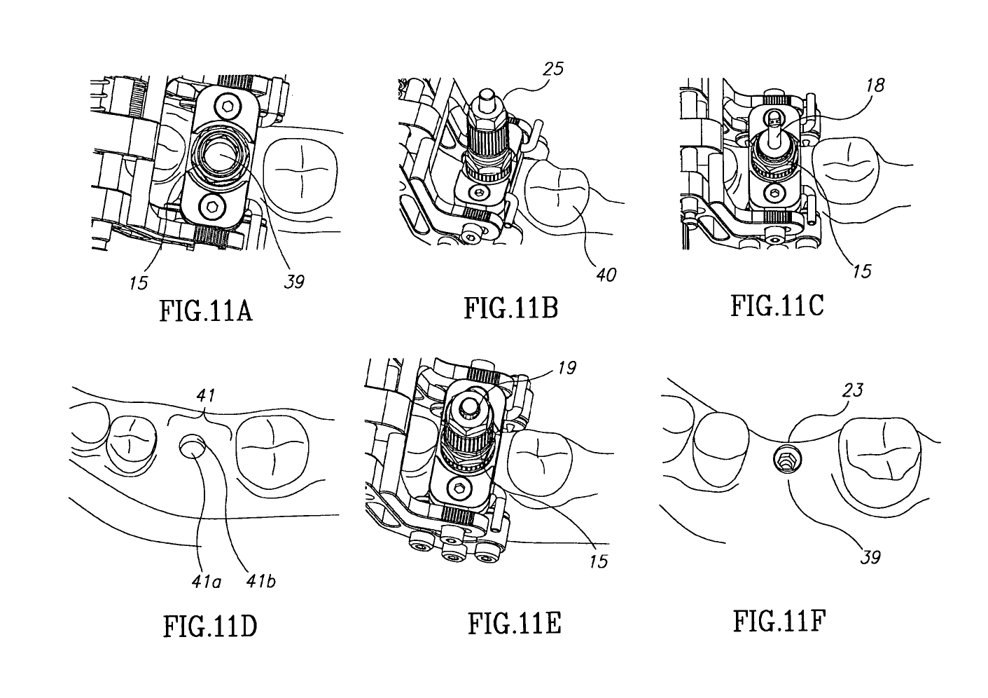

FIGS. 11A-11F are graphical illustrations of a mandible being setup for a delayed surgical technique implanting treatment using a surgical implant clamping apparatus of the present invention, according to some embodiments. As can be seen in FIG. 11A, after the Surgical clamp apparatus 1 is placed and secured in position over a treatment area, the Drilling Guide Ring 15 is positioned over the Target implant site 39. In FIG. 11B, the Calibrated Adjustable gum thickness gauge 25 may be inserted into the Drill guide ring 15 and screwed down until its probe penetrates the gum tissue to the level of the bone. In FIG. 11C the Drill bit 18 is inserted into the Drill guide ring 15 and rotated down (utilizing the handpiece 17—not shown) until it rests on the upper limiting flange 15a (not shown) of the Drill guide ring 15. In FIG. 11D, an unobstructed view (the clamp apparatus 1 has been removed from the drawing for illustration purposes only) of the Completed osteotomy 41 (prepared in FIG. 11c) is revealed, in which the Completed osteotomy bony floor 41a and the Completed osteotomy bony side wall 41b can be seen. In FIG. 11E the Calibrated Adjustable implant driver 19 (set to the pre-determined length) is inserted (with attached implant—not shown) into the Drill guide ring 15 and screwed down until it rests on the upper limiting flange 15d of the Drill guide ring 15 and may be used to precisely drive the implant into the completed osteotomy 41 via the Drill guide ring (which remains at the height previously set by the Gum thickness gauge 25) to the correct pre-determined depth. In FIG. 11F the Dental Implant 23 can be seen implanted in the target implant site 39 to the desired pre-determined depth.

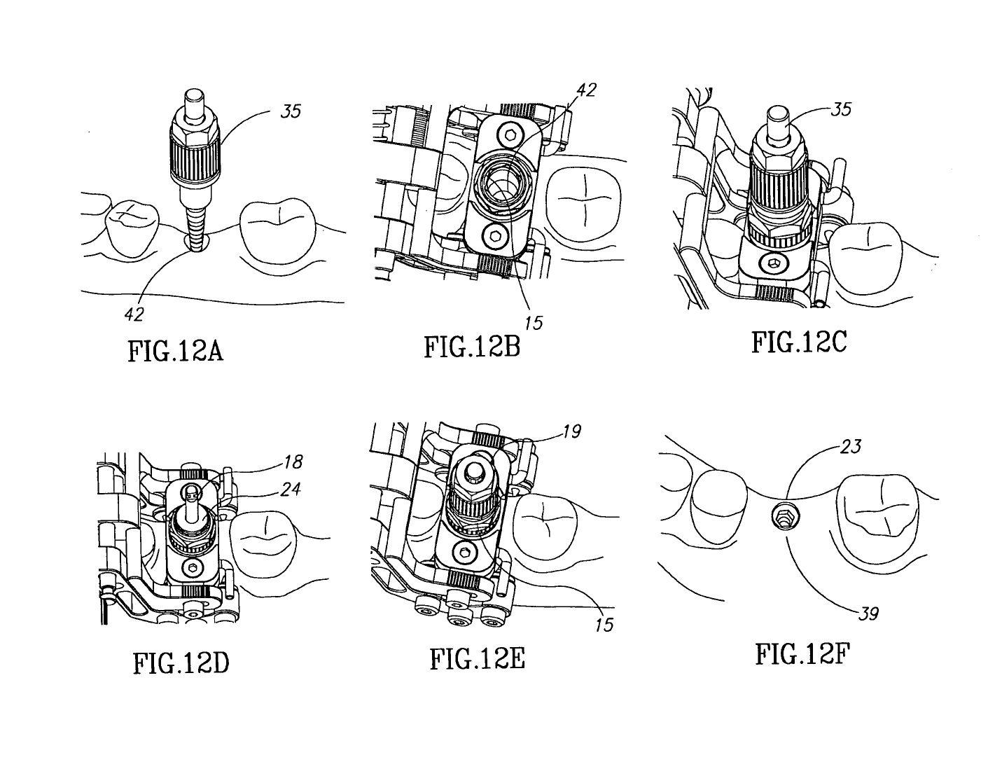

FIGS. 12A-12F are further graphical illustrations of a mandible being setup for an immediate surgical technique implantation treatment using a surgical implant clamping apparatus 1 of the present invention, according to some embodiments. In FIG. 12A the Extraction socket adjustable gauge 35 can be seen entered into the fresh Extraction socket 42 and its inner adjustable shaft 36 pressed into the socket void to measure the depth of the socket, and so to verify the depth and angle etc. of the desired osteotomy preparation to be drilled for the insertion of the implant into the completed osteotomy (see FIG. 12c). In FIG. 12B the clamp apparatus with Drilling Guide Ring 15 can be seen positioned directly over the Extraction socket 42. In FIG. 12C, the Extraction socket adjustable gauge 35 can be seen inserted into the drilling guide ring 15 of the drilling guide ring assembly 16, to establish the optimal path for drilling mentioned above, which, once discovered via the gauge 35, can be locked or fixed in place utilizing the locking screws 3c and the Guide ring locking nut 14.

In FIG. 12d the drill bit 18 is inserted into the drill guide ring 15 and rotated (utilizing the handpiece—not shown) until the limiting flange of the drill bit bushing 24 rests on the upper limiting flange 15d (not shown) of the drill guide ring 15. In FIG. 12e the Calibrated adjustable Implant driver with implant connected to it (not shown) is inserted into the drill guide ring 15 until it rests on the upper limiting flange 15d and so precisely drives the implant to the correct pre-determined depth. In FIG. 12F the Dental Implant 23 can be seen implanted in the target implant site 39 to the desired pre-determined depth.

According to some embodiments, a process is provided that comprises the steps of: clamping a dental implantation apparatus to a jawbone, wherein the dental implantation apparatus includes a platform for guiding one or more tools for preparing an osteotomy and/or for implanting a dental implant into a jawbone; adjusting the position of the platform relative to the jawbone after the apparatus has been attached to the jawbone; and maintaining the position of the platform while performing one or more steps of preparing an osteotomy and/or implanting a dental implant.

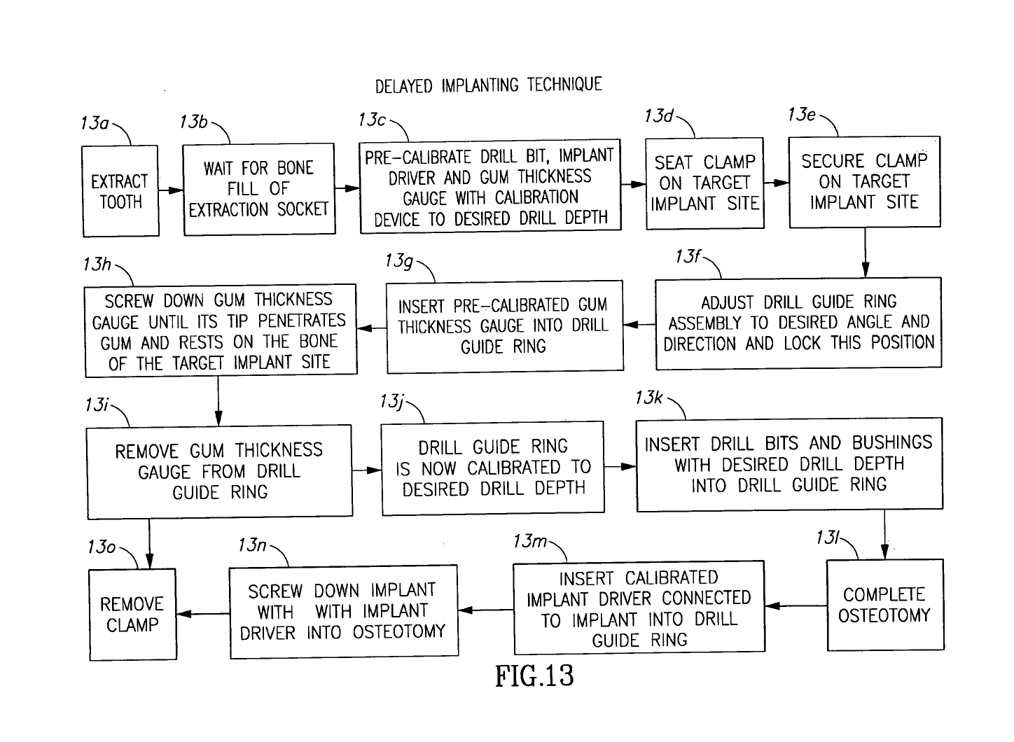

FIG. 13 schematically illustrates a series of operations or processes that may be implemented to prepare a jaw bone for immediate placement of a dental implant, according to some embodiments. As can be seen in FIG. 13, at step 13a, the tooth or teeth needing to be replaced by an implant is extracted. At step 13b, the bone is given time to fill the socket of the extracted tooth. At step 13c, prior to the implant preparation and installation procedure, the selected drill bit, Implant Driver and Gum thickness Gauge may be Calibrated to a desired drill depth, with a Calibration Device. At step 13d a surgical guide clamp is seated on the target site. At step 13e a surgical guide clamp is secured on the target site. At step 13f the Drill guide ring assembly may be adjusted to a desired angle and direction, and is locked in this position. At step 13g, the Calibrated Gum thickness Gauge is entered into Drill guide ring. At step 13h the Gum thickness gauge is screwed down until its tip penetrates gum and rests on the bone of the target implant site. At step 13i the Gum thickness Gauge is removed from the Drill guide ring. At step 13j the drill guide ring is calibrated to the desired drill depth. At step 13 k the drill bits and bushings with desired drill depth are inserted into the Drill guide ring. At step 13l the Osteotomy (bone preparation) is completed, using the selected drill bit, length, angle etc. At block 13m the Calibrated Implant Driver connected to the Implant is inserted into the Drill Guide Ring. At block 13n the implant is screwed down with the Implant Driver into the Osteotomy. At step 13o the clamp may be removed. Further, other steps or series of steps may be used.

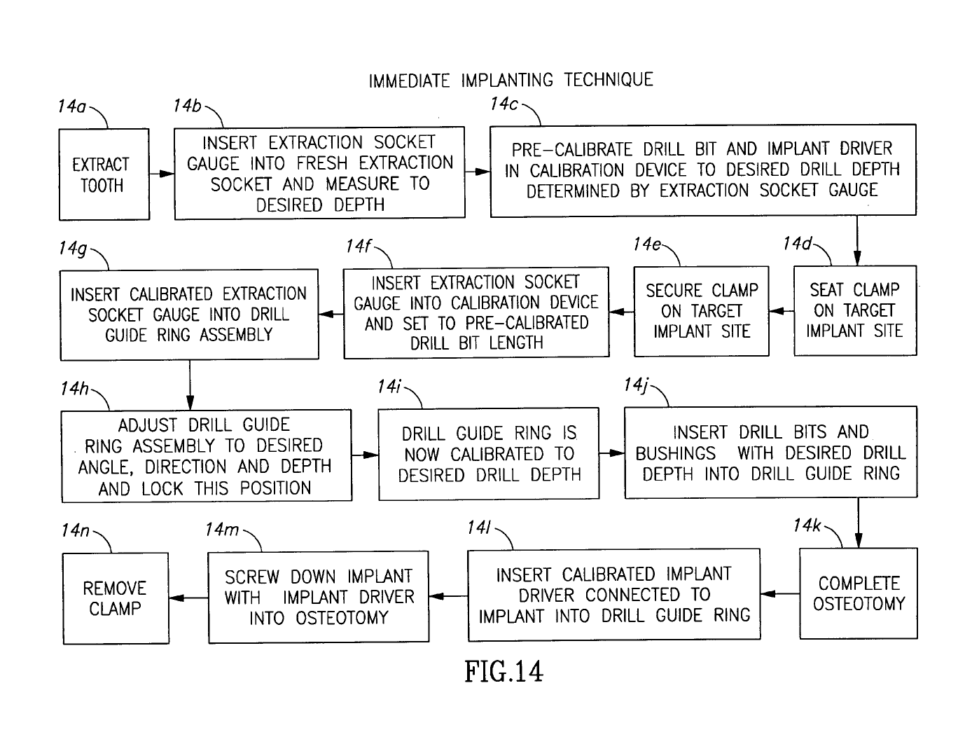

FIG. 14 schematically illustrates a series of operations or processes that may be implemented to prepare a jaw bone for delayed placement of a dental implant, according to some embodiments. As can be seen in FIG. 14, at step 14a, the Extraction Socket Gauge is inserted into the Fresh extraction socket, to measure the socket depth. At step 14c, prior to the implant preparation and installation procedure, the selected drill bit, Implant Driver and Gum thickness Gauge may be Calibrated to a desired drill depth, with a Calibration Device, in accordance with the depth measured by the Extraction Socket Gauge. At step 14d a surgical guide clamp is seated on the target site. At step 14e a surgical guide clamp is secured on the target site. At step 14f the Extraction Socket Gauge is inserted into the Calibration device and set to Calibrated drill bit length. At step 14g insert the Calibrated Extraction Socket Gauge into the Drill Guide Ring assembly. At step 14h the Drill guide ring assembly may be adjusted to a desired angle and direction, and is locked in this position. At step 14i, the Drill guide ring is now calibrated to desired drill depth. At block 14j the drill bits and bushings with desired drill depth are inserted into the Drill guide ring. At step 14k the Osteotomy (bone preparation) is completed, using the selected drill bit, length, angle etc. At block 14l the Calibrated Implant Driver is connected to the Implant and inserted into the Drill Guide Ring. At block 14m the implant is screwed down with with Implant Driver into the Osteotomy. At step 14n the clamp may be removed. Further, other steps or series of steps may be used.

According to some embodiments, a kit is provided that includes any combination of two or more of an implant driver tool, a gum thickness gauge, an extraction socket gauge, or a calibration device.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. An apparatus comprising:
i. a platform suitable for being positioned over a bone and maintained in position for a procedure including a. preparing a bone for an implant and/or b. implanting an implant into a bone;
ii. an outer frame connected to the platform, wherein the outer frame includes two clamp arms for extending to opposing sides of the bone, wherein the two clamp arms are connected by an arm connection screw to enable the two clamp arms to be closed simultaneously;
iii. a plurality of fixation cleats connected to each clamp arm, wherein each fixation cleat has a tip suitable for penetrating into a bone and/or gum tissue on the opposing sides of the bone so that the frame is secured to the bone during the procedure; and
iv. one or more means for adjusting the position of at least one fixation cleats for securing the clamp arms to the bone prior to and/or during the procedure and for removing the clamp arms from the bone after the procedure.

2. The apparatus of claim 1, wherein the bone is a jaw bone, and the clamp arms can be positioned with one clamp arm on the lingual side of the jawbone and the other clamp arm on the labial side of the jawbone, wherein the clamp arms are generally in parallel, and more than one of the fixation cleats are connected to each of the two clamp arms.

3. The apparatus of claim 1, wherein the apparatus includes one or more features for positioning the platform, for changing a position of the platform, and/or for changing an angle of a component of the platform relative to the bone, or any combination thereof, following the securing of the clamp arms to the bone and prior to the procedure.

4. The apparatus of claim 1, wherein at least a portion of the platform includes one or more features for changing an angle of the platform relative to the bone, so that the apparatus can be used for a preparing multiple dental osteotomies having bores with different angles.

5. The apparatus of claim 4, wherein at least a portion of the platform includes one or more features for changing the direction of an angle of the platform relative to the bone, so that the apparatus can be used for preparing multiple dental osteotomies having bores with different angles and different directions of the angles.

6. The apparatus of claim 1, wherein at least a portion of the platform includes one or more features for changing the effective drilling height of the platform relative to the bone, so that the apparatus can be used for preparing a plurality of osteotomies having bores of different depths.

7. The apparatus of claim 1, wherein the arms of the frame have an upper region that extend above the crestal height and the occlusal plane of the teeth, wherein the upper region of the arms have a plurality of bore holes and are connected by one or more arm connection screws extending through a bore hole of each arm and by one or more arm guide pins extending through a bore hole of each arm, wherein the bore holes are aligned so that the arms are maintained in a generally parallel relationship.

8. The apparatus of claim 1, wherein the platform is connected to an inner frame, the inner frame has an upper portion, wherein the upper portion of the inner frame has bore holes for receiving the arm guide pins and the arm connection screw, wherein the bore holes of the upper portion of the inner frame have one or more features for securing the inner frame in a fixed position relative to the arm connection screws and the arm guide pins.

9. The apparatus of claim 1, wherein the arm connection screw is a left/right bolt that enables both of the arms of the outer frame can be simultaneously and/or equally moved towards or away from the platform.

10. The apparatus of claim 1, wherein the platform includes a lower guide platform and an upper guidance platform.

11. The apparatus of claim 1, wherein the platform includes a swivel nut positioned between the lower guide platform and the upper guide platform.

12. The apparatus of claim 1, wherein the each arm of the outer frame has internally threaded bore holes for each of the cleats so that the each of the cleats can be screwed individually against the gum, and the arm connection screw has a nob for screwing the arms together so that the cleats can evenly penetrate the gum tissue and/or the bone independent of the curvature of the gum tissue and/or bone.

13. The apparatus of claim 1, wherein the upper and lower guide platforms incorporate internal irrigation channels for directing irrigation fluid into the implanting bone site.

14. The apparatus of claim 1, further comprising means for adjusting one or any combinations of the following:
a) adjusting the buccal to lingual position of the platform;
b) adjusting the tilt angle of at least a portion of the platform relative to the vertical axis;
c) adjusting the anterior to posterior position of the platform; and/or
d) adjusting the direction of the projection of the tilt angle of the at least a portion of the platform onto the plane perpendicular to the vertical axis.

15. The apparatus of claim 2, further comprising means for measuring a distance between a portion of the platform and a crestal region of the jawbone for calibrating the depth for a step of preparing an osteotomy, wherein the step of measuring occurs after a step of adjusting the position of the platform.

16. The apparatus of claim 1, further comprising a calibration device, comprising:
a. a top portion having one or more bore holes for receiving one or more gauges;
b. a bottom portion that is spaced apart from the top portion; wherein the spacing between the top and bottom portion is adjustable;
wherein the spacing between the top portion and the bottom portion can be set to a set position using a guide pin having a limiting flange ring for contacting the bottom portion, wherein the spacing is capable of being set by placing a gauge through one of the bore holes of the top portion so that the gauge just touches the top surface of the bottom portion,
wherein the bottom portion has a bore hole for receiving a drill bit and/or an extraction socket gauge so that the drill bit or extraction socket gauge extends to the upper portion; and wherein the upper portion has calibration markings for calibrating the drill bit or the extraction socket gauge;
so that the calibration apparatus can be used for drilling an osteotomy having a predetermined depth, and or for inserting an implant into an osteotomy to a predetermined depth.

17. The apparatus of claim 1, further comprising an extraction socket gauge for measuring the depth of an extraction socket using an extraction socket gauge, wherein the extraction socket gauge has an adjustable sliding center measuring element that can be locked at various lengths relative to the body of said extraction socket gauge for the accurate measuring of an extraction socket.

18. The apparatus of claim 2, wherein the apparatus further comprises a gum thickness gauge for measuring the thickness of gum tissue overlying the alveolar crest of a jawbone, the gum thickness gauge having an adjustable sliding center measuring element that can be locked at various lengths relative to the body of said gum thickness gauge for the accurate measuring of the thickness of the gum tissue overlying the alveolar crest of a jawbone.

19. The apparatus of claim 1, further comprising an implant driver tool having an adjustable sliding center shaft element that can be locked at various lengths relative to the body of said implant driver tool for insertion into a drill guide ring, whereby the protruding length of the shaft determines the depth of insertion.

20. A kit including an apparatus according to claim 1 in combination with two or more of an implant driver tool, a gum thickness gauge, an extraction socket gauge and a calibration device.
